(19) United States
(12) Patent Application Publication
(10) Pub. No.: US 2005/0195703 A1
(43) Pub. Date: Sep. 8, 2005

(54) Objective lens drive device and optical head device provided with the same

(76) Inventor: Tatsuki Wade, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/063,401

(22) Filed: Feb. 22, 2005

(30) Foreign Application Priority Data
Feb. 23, 2004 (JP) 2004-046895

(51) Int. Cl. G11B 7/00

(52) U.S. Cl. 369/44.15; 369/44.32

(57) ABSTRACT

An objective lens drive device includes an objective lens, a lens holder having a lens holding part for holding the objective lens on one side end part of the lens holder, a focusing and tracking drive mechanism, and a tilt drive mechanism. The focusing and tracking drive mechanism and the tilt drive mechanism are disposed so as to be separated from each other in a longitudinal direction which is from the one side end part of the lens holder to the other side end part of the lens holder. More specifically, the tracking drive mechanism is disposed on the tilt drive mechanism side and the focusing drive mechanism is disposed on an opposite side to the tilt drive mechanism with the tracking drive mechanism interposing therebetween.

### CROSS-REFERENCE TO RELATED APPLICATIONS

This application claims priority to Japanese Application No. 2004-46895 filed Feb. 23, 2004, which is incorporated herein by reference.

### FIELD OF THE INVENTION

The present invention relates to a so-called wire suspension type of objective lens drive device and an optical head device provided with the objective lens drive device.

### BACKGROUND OF THE INVENTION

As an optical head device which is used for recording or reproducing information into or from an optical recording disk such as a CD or a DVD, an optical head device provided with a so-called wire suspension type of objective lens drive device has been known, which includes an objective lens, a lens holder which holds the objective lens, a fixed side member which supports the lens holder in a movable manner with a plurality of wires, a focusing and tracking drive mechanism for driving the lens holder in a focusing direction and in a tracking direction, and a tilt drive mechanism for driving the lens holder in a tilt direction.

In the objective lens drive device used in the optical head device, for example, a tilt drive mechanism is used which includes a tilt drive coil and a pair (two) of tilt drive magnets (see, for example, Japanese Patent Laid-Open No. 2003-303432 and Japanese Patent Laid-Open No. 2003-272201).

Another tilt drive mechanism is used which includes a pair of tilt drive coils and a pair of tilt drive magnets (see, for example, Japanese Patent Laid-Open No. 2003-196871 and Japanese Patent Laid-Open No. 2003-85798).

In recent years, the downsizing of an entire optical head device has been required in order to mount it in a notebook-sized personal computer. Therefore, the downsizing of the objective lens drive device for constructing the optical head device has been also required.

However, in the conventional objective lens drive device, when the objective lens drive device is made smaller by disposing the respective drive mechanisms in a close proximity relation, the focusing drive mechanism, the tracking drive mechanism and the tilt drive mechanism magnetically affect one another so as to cause problems such as the occurrence of unnecessary resonance. Also, when the objective lens drive device is made smaller by downsizing magnetic members for constructing the focusing drive mechanism, the tracking drive mechanism and the tilt drive mechanism, the sensitivity may be remarkably reduced. In addition, when the objective lens drive device is made smaller, the aberration of the objective lens may deteriorate due to heat generated in the coils of the respective drive mechanisms.

### OBJECTS, ADVANTAGES AND SUMMARY OF THE INVENTION

In view of the problems described above, it is a primary object and advantage of the present invention to provide an objective lens drive device which is capable of downsizing without causing unnecessary resonance, and to provide an optical head device provided with the objective lens drive device.

In addition, it is another object and advantage of the present invention to provide an objective lens drive device which is capable of preventing the reduction of sensitivity when magnetic members for constructing the drive mechanism are made smaller, and to provide an optical head device provided with the objective lens drive device.

Furthermore, it is another object and advantage of the present invention to provide an objective lens drive device which is capable of restricting the affection of heat caused by the coils of the drive mechanisms to the objective lens, and to provide an optical head device provided with the objective lens drive device.

In order to achieve the above primary object and advantage, according to an embodiment of the invention, there is provided an objective lens drive device including an objective lens, a lens holder which is provided with a lens holding part for holding the objective lens on one side end part of the lens holder, a fixed side member which supports the lens holder with a plurality of wires, a focusing and tracking drive mechanism for driving the lens holder in a focusing direction and in a tracking direction, and a tilt drive mechanism for driving the lens holder in a tilt direction. The focusing and tracking drive mechanism and the tilt drive mechanism are disposed so as to be separated from each other in a longitudinal direction from the one side end part of the lens holder to the other side end part of the lens holder. The plurality of wires in the embodiment of the present invention may use not only a normal round bar-shaped wire but also a plate bar which is formed in a thin plate, a rectangular plate bar or the like. In other words, the cross-sectional shape of the wire is not limited to a circular shape but also to a rectangular shape.

In accordance with an embodiment of the present invention, a back yoke of the tilt drive mechanism is preferably located between a region where the focusing and tracking drive mechanism is disposed and a region where the tilt drive mechanism is disposed. In this case, the back yoke is interposed between the focusing and tracking drive mechanism and the tilt drive mechanism.

In accordance with an embodiment of the present invention, the focusing and tracking drive mechanism includes a focusing drive mechanism and a tracking drive mechanism, and preferably the tracking drive mechanism is disposed on the tilt drive mechanism side and the focusing drive mechanism is disposed on the opposite side to the tilt drive mechanism with interposing the tracking drive mechanism therebetween. According to the construction described above, the focusing drive mechanism, which is easy to be affected by the tilt drive mechanism, is spatially separated from the tilt drive mechanism. Therefore, the occurrence of unnecessary resonance can be surely prevented.

In accordance with an embodiment of the present invention, the focusing and tracking drive mechanism includes a focusing drive coil, a focusing drive magnet which is disposed on an inner side of the focusing drive coil, tracking drive coils which are adjacent to the focusing drive coil in the longitudinal direction of the lens holder, and a tracking drive magnet which faces the tracking drive coils in the longitudinal direction of the lens holder. The tilt drive mechanism includes at least a tilt drive coil which faces the tracking drive coils in the longitudinal direction of the lens holder and a tilt drive magnet which faces the tilt drive coil in the longitudinal direction of the lens holder. According to the construction described above, respective magnetic members are not required to be made smaller because the number of the magnetic members for constructing the drive mechanisms is reduced, and thus the reduction of sensitivity can be prevented.

In this case, the tilt drive coil is preferably wound around in a rectangular shape such that an opposing face of the tilt drive coil to the tilt drive magnet is provided with longitudinal side parts and lateral side parts. The tilt drive magnet preferably includes four magnetized parts on an opposing face to the tilt drive coil, and the four magnetized parts are polarized and magnetized into four poles by the polarization lines which are parallel with the longitudinal side part and the lateral side part of the tilt drive coil. An N-pole and an S-pole are alternately magnetized on the four magnetized parts along a winding direction of the tilt drive coil, and the longitudinal side parts and the lateral side parts of the tilt drive coil are respectively disposed so as to extend over two magnetized parts of the four magnetized parts of the tilt drive magnet.

In accordance with an embodiment of the present invention, the tilt drive coil may be comprised of one piece of coil which is wound around in a rectangular shape provided with longitudinal side parts and lateral side parts, or may be comprised of a plurality of coils which are respectively wound around in a rectangular shape. In the case that a plurality of coils are disposed, two coils, which are wound around so as to be connected in an opposite direction to each other, may be disposed side by side at a position opposing to the tilt drive magnet. Alternatively, a plurality of coils which are wound around so as to be connected in the same direction each other may be disposed side by side at a position opposing to the tilt drive magnet.

For example, in accordance with an embodiment of the present invention, the tilt drive coil includes two coils which are respectively wound around in a rectangular shape provided with longitudinal side parts and lateral side parts, and the two coils are disposed side by side in a lateral direction and are supplied with electric power in an opposite direction to each other. Also, the tilt drive magnet includes two magnetized parts on the opposing face of the tilt drive magnet to the two coils, and the two magnetized parts are polarized and magnetized into two poles by a polarization line which is parallel with the lateral side part of the tilt drive coil.

In accordance with an embodiment of the present invention, the tilt drive magnet is preferably comprised of one piece of magnet which is disposed at a position opposing to the tilt drive coil. Alternatively, the tilt drive magnet may be constructed such that a plurality of magnets each of which is magnetized with single pole are integrated with each other, or such that the plurality of magnets are disposed in a close proximity relation.

In accordance with an embodiment of the present invention, the tilt drive mechanism is preferably disposed on the other side end part side which is the opposite side to the lens holding part of the lens holder. According to the construction described above, the tilt drive mechanism in which the coil generates heat most can be spatially separated from the objective lens. Therefore, the deterioration of aberration occurred in the objective lens due to the heat generated in the coils of the respective drive mechanisms can be prevented.

In this case, the tilt drive coil or the tilt drive magnet of the tilt drive mechanism which is mounted on the lens holder is preferably used as a counterweight for the lens holder which holds the objective lens.

The objective lens drive device in accordance with the embodiments of the present invention are used in an optical head device.

As described above, in the focusing drive mechanism, the tracking drive mechanism and the tilt drive mechanism, the tilt drive mechanism may cause magnetic attraction and unnecessary resonance may result in the focusing drive mechanism. However, in the objective lens drive device in the present invention, the focusing and tracking drive mechanism comprised of the focusing drive mechanism and the tracking drive mechanism is disposed so as to be spatially separated from the tilt drive mechanism in the longitudinal direction of the lens holder. Therefore, the magnetic interference between the tilt drive mechanism and the focusing drive mechanism can be prevented. Accordingly, even when the respective drive mechanisms are disposed in a close relation, unnecessary resonance will not occur.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a perspective view showing an objective lens drive device in accordance with an embodiment of the present invention;

FIG. 2(A) is a front view of a tilt drive magnet which is used in the objective lens drive device shown in FIG. 1 and FIG. 2(B) is its side view;

FIG. 3 is an explanatory view showing the arrangement relationship of a tilt drive coil and the tilt drive magnet viewed from the tilt drive coil side, which are used in the objective lens drive device shown in FIG. 1; and

FIG. 4 is an explanatory view of two tilt drive coils and a tilt drive magnet which are used in an objective lens drive device in accordance with another embodiment of the present invention.

### DESCRIPTION OF THE PREFERRED EMBODIMENTS

An objective lens drive device in accordance with an embodiment of the present invention will be described below with reference to the accompanying drawings.

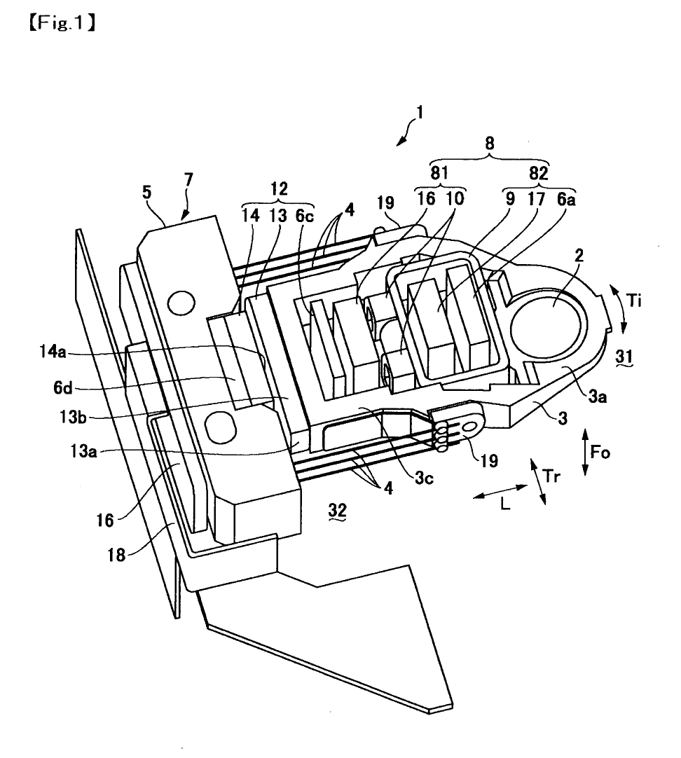

FIG. 1 is a perspective view showing an objective lens drive device in accordance with an embodiment of the present invention.

An objective lens drive device 1 shown in FIG. 1, to which the present invention is applied, is provided with a prescribed optical system and is used in an optical head device for recording or reproducing information on or from an optical recording disk such as a CD or a DVD. The construction members for the optical head device such as a device frame may utilize well-known components and thus their descriptions are omitted. The objective lens drive device 1 includes an objective lens 2, a lens holder 3 which holds the objective lens 2, a fixed side member 7 which movably supports the lens holder 3 with six wires 4 in a focusing direction (direction shown by the arrow “Fo”), in a tracking direction (direction shown by the arrow “Tr”), and in a tilt direction (direction shown by the arrow “Ti”), a focusing and tracking drive mechanism 8 which drives the lens holder 3 in the focusing direction “Fo” and in the tracking direction “Tr”, and a tilt drive mechanism 12 which drives the lens holder 3 in the tilt direction “Ti”. The wire 4 may use a normal round bar-shaped wire, but a bar-shaped plate made of a thin plate whose cross-section is in a rectangular shape may be used as the wire 4. The bar-shaped plate may be easily constructed by punching a thin plate by using a press machine and a punched plate may be used as the wire 4.

The fixed side member 7 includes six wires 4 which support the lens holder 3 on their tip ends side, a holder support member 5 which supports the wires 4 on their base ends side, and a yoke which constructs the main body frame at an under position of the lens holder 3 and also constructs one part of the focusing and tracking drive mechanism 8 and the tilt drive mechanism 12. The main body part of the yoke is not shown in the drawing. The holder support member 5 is fixed on the yoke by a fixing means such as an adhesive.

The lens holder 3 is provided with a body part 3c which is formed in a rectangular and tubular shape and a ring-shaped lens holding part 3a which is integrally formed with the body part 3c. The objective lens 2 is held on the lens holding part 3a. The lens holder 3 is supported with six wires 4 which are disposed on both sides in the tracking direction and three wires are disposed in the focusing direction on either side. The six wires 4 are also respectively used as a power feeding wire for a focusing drive coil 9, tracking drive coils 10 and a tilt drive coil 13. Therefore, the tip end sides of the respective wires 4 are soldered and fixed to relay circuit boards 19, which are fixed on both sides of the lens holder 3 in the tracking direction. The base ends of the wires 4 are respectively soldered on the wiring patterns of a printed circuit board 16 which is mounted on the back face of the holder support member 5. A flexible circuit board 18 for performing power feeding to the wires 4 is soldered and fixed on the printed circuit board 16.

In the objective lens drive device 1, the side where the lens holding part 3a of the lens holder 3 is formed is defined as one side end part 31 and the opposite side is defined as the other side end part 32 (base end side of the wires 4), and the direction from the one side end part 31 toward the other side end part 32 is defined as the longitudinal direction “L”. In the objective lens drive device 1 in accordance with the embodiment of the present invention, the focusing and tracking drive mechanism 8 and the tilt drive mechanism 12 are disposed so as to be spatially separated from each other in the longitudinal direction “L” of the lens holder 3. In other words, the focusing and tracking drive mechanism 8 is disposed nearer to the one side end part 31 where the lens holding part 3a is formed than the central region in the longitudinal direction “L” of the lens holder 3. The tilt drive mechanism 12 is disposed nearer to the other side end part 32 which is on the opposite side of the lens holding part 3a of the lens holder 3. In addition, the back yoke 6c of the tilt drive mechanism 12, which is cut and raised from the yoke, is located between the region where the focusing and tracking drive mechanism 8 is disposed and the region where the tilt drive mechanism 12 is disposed. The focusing and tracking drive mechanism 8 and the tilt drive mechanism 12 are disposed so as to interpose the back yoke 6c. The tracking drive mechanism 81 of the focusing and tracking drive mechanism 8 is disposed on the side where the tilt drive mechanism 12 is disposed. The focusing drive mechanism 82 is disposed on the opposite side of the tilt drive mechanism 12 with respect to the tracking drive mechanism 81.

In the embodiment of the present invention, the focusing and tracking drive mechanism 8 includes a focusing drive coil 9 which is adhered and fixed on the inner side of the body part 3c of the lens holder 3, a focusing drive magnet 17 which is disposed in the inner side of the focusing drive coil 9, two tracking drive coils 10 which are disposed so as to be adjacent to the focusing drive coil 17 in the longitudinal direction “L” on the lens holder 3, and a tracking drive magnet 16 which faces the tracking drive coils 10 in the longitudinal direction “L” on the lens holder 3. The focusing drive coil 9, the tracking drive coils 10 and the tracking drive magnet 16 are disposed in this order from the one side end part 31 to the other side end part 32 in the longitudinal direction “L” of the lens holder 3.

The focusing drive coil 9 is wound around in a rectangular shape and three sides of the outer peripheral side of the focusing drive coil 9 are fixed on the inner peripheral side of the body part 3c of the lens holder 3 with an adhesive or the like. In the embodiment of the present invention, a clad wire is used for the focusing drive coil 9, which is constructed such that aluminum is used as a core member that is covered with copper, to reduce its weight. The tracking drive coils 10 are comprised of two flat coils and adhered to the remaining side outer face (other than the above-mentioned three sides) of the focusing drive coil 9. The tracking drive magnet 16 is held on the fixed side member 7 so as to face the inner longitudinal sides of the two tracking drive coils 10. The focusing drive magnet 17 is held on the fixed side member 7 at a position so as to face one side of the focusing drive coil 9 and interpose the inner longitudinal sides of the two tracking drive coils 10 between the tracking drive magnet 16 and the focusing drive magnet 17. A holding part 6a which is cut and raised from the yoke is disposed between the focusing drive magnet 17 and the focusing drive coil 9 on the one side end part 31 side of the lens holder 3.

The tilt drive mechanism 12 includes a back yoke 6c which is located on the other side end part 32 side in the longitudinal direction “L” of the lens holder 3 so as to face the tracking drive coils 10, a tilt drive coil 13 which is located on the other side end part 32 side in the longitudinal direction “L” of the lens holder 3 so as to face the tracking drive coils 10 with the back yoke 6c interposing therebetween, and a tilt drive magnet 14 which is located on the other side end part 32 side in the longitudinal direction “L” of the lens holder 3 so as to face the tilt drive coil 13.

The tilt drive coil 13 is a flat coil that is wound around in a rectangular shape such that its opposed face to the tilt drive magnet 14 includes longitudinal side parts 13a and lateral side parts 13b. The tilt drive coil 13 is adhered on the outer face of the body part 3c in the other side end part 32 of the lens holder 3.

The tilt drive magnet 14 is formed in a flat rectangular solid shape whose longitudinal side in the drawing is set to be short. The tilt drive magnet 14 is fixed on the holding part 6d which is cut and raised from the yoke such that its opposed face 14a faces the tilt drive coil 13 and therefore the tilt drive magnet 14 is held by the fixed side member 7.

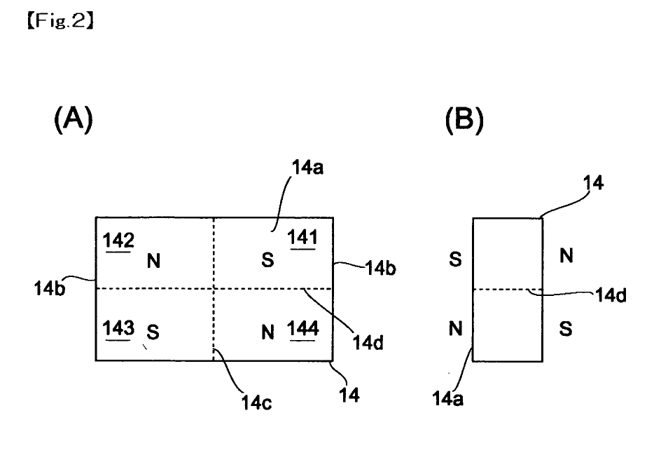

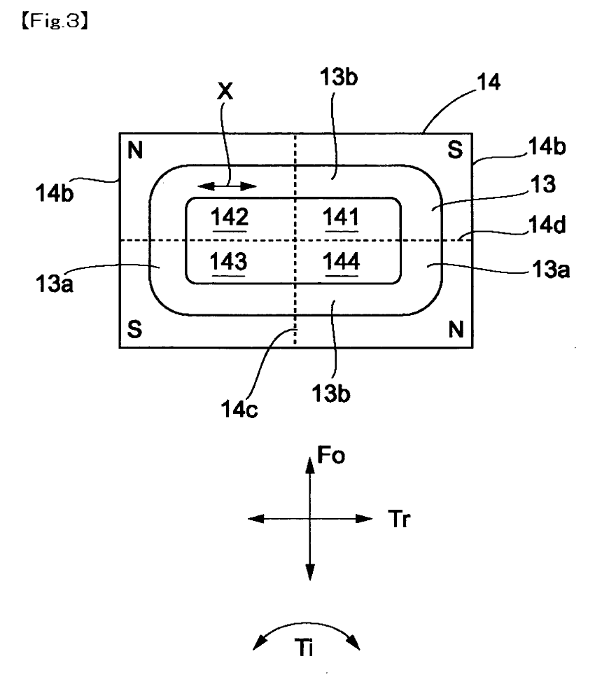

FIG. 2(A) is the front view of the tilt drive magnet 14 which is used in the objective lens drive device 1 shown in FIG. 1, and FIG. 2(B) is its side view. FIG. 3 is an explanatory view showing the arrangement relationship of the tilt drive coil 13 and the tilt drive magnet 14 viewed from the tilt drive coil side in the objective lens drive device 1 in accordance with the embodiment of the present invention.

As shown in FIGS. 2(A), 2(B) and FIG. 3, the tilt drive coil 13 and the tilt drive magnet 14 are opposedly arranged such that the longitudinal side part 13a of the tilt drive coil 13 and the short side part 14b of the tilt drive magnet 14 in the longitudinal direction are approximately parallel to each other.

The tilt drive magnet 14 includes four magnetized parts which are polarized and magnetized to four poles so as to have a polarization line 14c formed in parallel with the longitudinal side part 13a of the tilt drive coil 13 and a polarization line 14d formed in parallel with the lateral side part 13b. In other words, the tilt drive magnet 14 is polarized and magnetized into four poles, which are a first magnetized part 141, a second magnetized part 142, a third magnetized part 143 and a fourth magnetized part 144. In addition, the first magnetized part 141 through the fourth magnetized part 144 are alternately magnetized to an N-pole or an S-pole along the winding direction “X” of the tilt drive coil 13. For example, the first magnetized part 141 is magnetized to an S-pole, the second magnetized part 142 to an N-pole, the third magnetized part 143 to an S-pole, and the fourth magnetized part 144 to an N-pole.

The longitudinal side parts 13a and the lateral side parts 13b of the tilt drive coil 13 are opposedly disposed to the tilt drive magnet 14 so as to extend over two adjacent magnetized parts of the first magnetized part 141 through the fourth magnetized part 144. In other words, in FIG. 3, for example, the longitudinal side part 13a on the right side in the drawing is opposedly disposed so as to extend over the first magnetized part 141 that is magnetized to the S-pole and the fourth magnetized part 144 that is magnetized to the N-pole. The lateral side part 13b on the upper side in the drawing is opposedly disposed so as to extend over the first magnetized part 141 and the second magnetized part 142 that is magnetized to the N-pole. Similarly, the longitudinal side part 13a on the left side in the drawing is opposedly disposed so as to extend over the second magnetized part 142 and the third magnetized part 143, and the lateral side part 13b on the lower side in the drawing is opposedly disposed so as to extend over the third magnetized part 143 and the fourth magnetized part 144.

Accordingly, when an electric current is supplied to the tilt drive coil 13 in a counterclockwise direction, a force in the leftward direction in the drawing is generated in the longitudinal side part 13a facing the first magnetized part 141 and the longitudinal side part 13a facing the second magnetized part 142, and a force in the rightward direction in the drawing is generated in the longitudinal side part 13a facing the third magnetized part 143 and the longitudinal side part 13a facing the fourth magnetized part 144.

In addition, a force in the downward direction in the drawing is generated in the lateral side part 13b facing the first magnetized part 141 and the lateral side part 13b facing the fourth magnetized part 144, and a force in the upward direction in the drawing is generated in the lateral side part 13b facing the second magnetized part 142 and the lateral side part 13b facing the third magnetized part 143. Therefore, the lens holder 3 is driven in the clockwise direction in the drawing, i.e., in the tilt direction by the above-mentioned forces.

When an electric current is supplied to the tilt drive coil 13 in the clockwise direction, forces in the opposite directions described above are respectively generated in the longitudinal side parts 13a and the lateral side parts 13b, and thus the lens holder 3 is tilt driven in the counterclockwise direction in FIG. 3.

As described above, in the focusing drive mechanism 82, the tracking driving mechanism 81 and the tilt drive mechanism 12, the tilt drive mechanism 12 may be easy to cause magnetic affection and occur unnecessary resonance in the focusing driving mechanism 82. However, in the objective lens drive device 1 in the embodiment of the present invention, the focusing and tracking drive mechanism 8 comprised of the focusing drive mechanism 82 and the tracking drive mechanism 81 is disposed so as to be spatially separated from the tilt drive mechanism 12 in the longitudinal direction “L” of the lens holder 3. Therefore, the magnetic interference between the tilt drive mechanism 12 and the focusing drive mechanism 82 can be prevented. Accordingly, even when the respective drive mechanisms are disposed in a close relation, unnecessary resonance does not occur.

Further, the tilt drive mechanism 12 is disposed on the other side end part 32 side which is on the opposite side to the lens holding part 3a of the lens holder 3. Therefore, the tilt drive mechanism 12 in which heat is generated most among the drive coils can be spatially separated from the objective lens 2. In other words, since an electric current is always applied to the tilt drive coil 13, heat is generated most in the tilt drive coil 13 among the above-mentioned three types of drive coils, and thus the tilt drive coil 13 is spatially separated from the objective lens 2. Accordingly, the deterioration of aberration in the objective lens 2 due to the heat generated in the tilt drive coil 13 can be prevented.

The tilt drive magnet 14 is provided with the first magnetized part 141 through the fourth magnetized part 144, which are polarized and magnetized into four poles by the polarization line 14c which is formed in parallel with the longitudinal side part 13a of the tilt drive coil 13 and the polarization line 14d formed in parallel with the lateral side part 13b. In addition, an N-pole and an S-pole are alternately magnetized to the first magnetized part 141 through the fourth magnetized part 144 along the winding direction “X” of the tilt drive coil 13. Furthermore, the longitudinal side parts 13a and the lateral side parts 13b of the tilt drive coil 13 are opposedly disposed to the tilt drive magnet 14 in the state that each of the longitudinal side parts 13a and the lateral side parts 13b is extended over two adjacent magnetized parts of the first magnetized part 141 through the fourth magnetized part 144. Therefore, the tilt drive mechanism 12 can be realized by using only one tilt drive magnet 14 without using a pair of tilt drive magnet separated from each other, and thus the number of the drive magnet and the drive coil is restricted to the minimum. Consequently, since the sizes of the drive magnet and the drive coil are not required to be reduced, the reduction of sensitivity can be prevented.

The tilt drive mechanism 12 is constructed by using the tilt drive coil 13 formed of a flat coil and the tilt drive magnet 14 formed of a flat magnet, and the tilt drive magnet 14 is disposed in a space between the lens holder 3 and the holder support member 5, which is a dead space in the wire suspension type of objective lens drive device 1. Therefore, the downsizing of the objective lens drive device 1 can be obtained even when the tilt drive mechanism 12 is incorporated.

In the embodiment of the present invention, the focusing and tracking drive mechanism 8 is disposed at a roughly central part of the lens holder 3. Therefore, the position of the center of gravity of the focusing and tracking drive mechanism 8 can be aligned to the position of the center of gravity of the objective lens drive device 1. Also, the aluminum clad wire is used for the focusing drive coil 9 to reduce its weight and thus the weight balance is improved. In addition, the objective lens 2 is held on the lens holding part 3a which is projected from one end side of the lens holder 3 in the direction perpendicular to both the focusing direction “Fo” and the tracking direction “Tr”, while the tilt drive mechanism 12 is disposed on the other end side of the lens holder 3. Therefore, the tilt drive coil 13 for constructing the tilt drive mechanism 12 is possible to be used as a counterweight, and thus the balance of the objective lens drive device 1 can be adequately maintained. As a result, a stable focusing control and tracking control are performed. Furthermore, since the tilt drive mechanism 12 is disposed on the base end side of the wires 4, the positional misalignment between the tilt drive coil 13 and the tilt drive magnet 14 can be made smaller at the time of driving in the tilt direction “Ti”. Therefore, an appropriate tilt driving is attained.

In the embodiment of the present invention, since the tilt drive coil 13 whose weight is lighter than the tilt drive magnet 14 is mounted on the lens holder 3, the increase of the weight of the lens holder 3 can be restricted. As a result, the degradation of the characteristics of the objective lens drive device 1 can be restricted.

The embodiment of the present invention is described above. However, needless to say, the present invention is not limited to the embodiment described above, and many modifications can be made without departing from the subject matter of present invention. For example, in the embodiment described above, one piece of the tilt drive magnet 14 is polarized and magnetized in four poles. However, four magnets respectively magnetized in single pole are integrally combined to construct the tilt drive magnet 14 provided with four poles. Alternatively, four magnets respectively magnetized in single pole may be positioned in a close relation one another to construct the tilt drive magnet 14 provided with four poles at one location in the objective lens drive device 1.

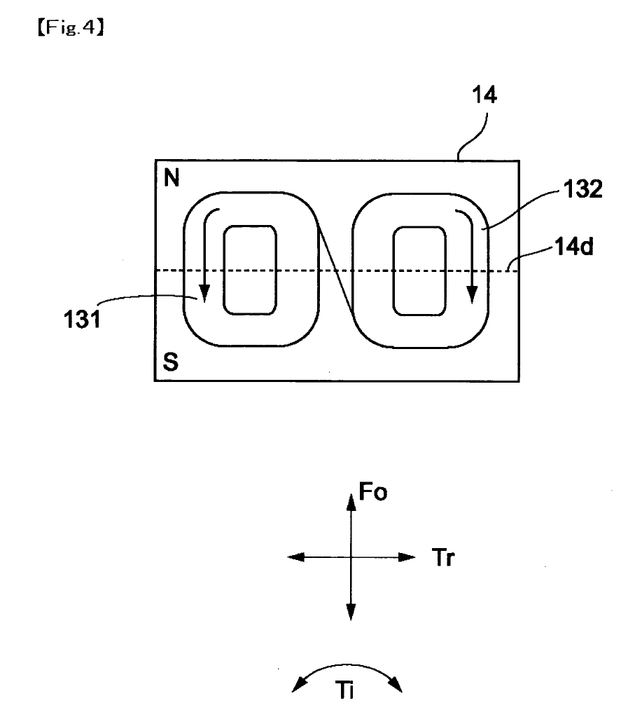

In addition, as shown in FIG. 4, the tilt drive coil 13 may be constructed such that two tilt drive coils 131, 132, which are respectively wound around in a rectangular flat shape having longitudinal side parts and lateral side parts and are wound around in the opposite direction to each other as shown by the respective arrows, are disposed side by side in a lateral (transverse) direction. The two tilt drive coils 131, 132 are supplied with an electrical power in the opposite direction to each other because the two tilt drive coils 131, 132 are wound around in the opposite direction to each other. In this case, the tilt drive magnet 13 is provided with two magnetized parts on an opposing face to the two tilt drive coils 131, 132, which are polarized and magnetized into two poles by the polarization line 14d which is parallel with the lateral side parts of the tilt drive coils. Alternatively, the tilt drive coil 13 may be constructed such that two flat-type tilt drive coils which are respectively wound around in the same direction are disposed side by side in a lateral (transverse) direction, and such that the two tilt drive coils are supplied with an electrical power in the same direction. In this case, the magnet as shown in FIGS. 2(A) and 2(B) may be preferably used as the tilt drive magnet 14.

In the embodiment of the present invention, the tilt drive coil 13 is mounted on the lens holder 3. However, the tilt drive coil 13 may be mounted on the yoke 6 (fixed side member 7) and the tilt drive magnet 14 is mounted on the lens holder 3 so as to be opposed each other. In this case, since the tilt drive magnet 14 is mounted on the lens holder 3, the position of the tilt drive magnet 14 varies and the lens holder 3 becomes heavy. Thus it may not be easy for the lens holder 3 to maintain its balance. However, power feeding to the lens holder 3 for the tilt drive coil 13 is not required and thus only four wires 4 are required. Accordingly, the device can be simplified to reduce the product cost.

The tilt drive mechanism 12 in accordance with the embodiment of the present invention may be arranged on both sides of the lens holder 3 in a radial disk direction. In this case, the tilt of the lens holder 3 can be adjusted in the tangential direction of the disk. For example, when the tilt drive mechanism 12 is constructed on both side faces of the lens holding part 3a of the lens holder 3, the tilt driving in the tangential direction of the disk can be attained.

As described above, the tilt drive mechanism may be easy to cause magnetic affection on the focusing drive mechanism and may occur unnecessary resonance in the focusing drive mechanism. However, according to the present invention, the focusing and tracking drive mechanism comprised of the focusing drive mechanism and the tracking drive mechanism is disposed so as to be spatially separated from the tilt drive mechanism in the longitudinal direction of the lens holder. Therefore, the magnetic interference between the tilt drive mechanism and the focusing drive mechanism can be prevented. Accordingly, even when the respective drive mechanisms are disposed in a close relation, unnecessary resonance does not occur.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An objective lens drive device comprising:
an objective lens;
a lens holder which is provided with a lens holding part for holding the objective lens on one side end part of the lens holder;
a fixed side member which supports the lens holder with a plurality of wires;
a focusing and tracking drive mechanism for driving the lens holder in a focusing direction and in a tracking direction; and
a tilt drive mechanism for driving the lens holder in a tilt direction;
wherein the focusing and tracking drive mechanism and the tilt drive mechanism are disposed so as to be separated from each other in a longitudinal direction which is from the one side end part of the lens holder to the other side end part of the lens holder.

2. The objective lens drive device according to claim 1, further comprising a back yoke of the tilt drive mechanism which is located between a region where the focusing and tracking drive mechanism is disposed and a region where the tilt drive mechanism is disposed such that the back yoke is interposed between the focusing and tracking drive mechanism and the tilt drive mechanism.

3. The objective lens drive device according to claim 1, wherein the focusing and tracking drive mechanism includes a focusing drive mechanism and a tracking drive mechanism, the tracking drive mechanism being disposed on the tilt drive mechanism side and the focusing drive mechanism being disposed on an opposite side to the tilt drive mechanism with the tracking drive mechanism interposed therebetween.

4. The objective lens drive device according to claim 3,
wherein the focusing and tracking drive mechanism includes a focusing drive coil, a focusing drive magnet which is disposed on an inner side of the focusing drive coil, tracking drive coils which are adjacent to the focusing drive coil in the longitudinal direction on the lens holder, and a tracking drive magnet which faces the tracking drive coils in the longitudinal direction on the lens holder, and
wherein the tilt drive mechanism includes at least a tilt drive coil which is parallel with the tracking drive coils in the longitudinal direction of the lens holder and a tilt drive magnet which faces the tilt drive coil in the longitudinal direction of the lens holder.

5. The objective lens drive device according to claim 4,
wherein the tilt drive coil is wound around in a rectangular shape such that an opposing face of the tilt drive coil to the tilt drive magnet is provided with longitudinal side parts and lateral side parts,
wherein the tilt drive magnet includes four magnetized parts on an opposing face to the tilt drive coil, the four magnetized parts being polarized and magnetized into four poles by the polarization lines which are parallel with the longitudinal side part and the lateral side part, and an N-pole and an S-pole being alternately magnetized on the four magnetized parts along a winding direction of the tilt drive coil, and
wherein the longitudinal side parts and the lateral side parts of the tilt drive coil are respectively disposed so as to extend over two adjacent magnetized parts of the four magnetized parts of the tilt drive magnet.

6. The objective lens drive device according to claim 4, wherein the tilt drive coil includes a plurality of coils which are disposed at a position opposing to the tilt drive magnet.

7. The objective lens drive device according to claim 6,
wherein the tilt drive coil includes two coils which are respectively wound around in a rectangular shape provided with longitudinal side parts and lateral side parts, the two coils being disposed side by side in a lateral direction and supplied with electric power in an opposite direction to each other, and
wherein the tilt drive magnet includes two magnetized parts on an opposing face of the tilt drive magnet to the two coils, the two magnetized parts being polarized and magnetized into two poles by a polarization line which is parallel with the lateral side part of the tilt drive coil.

8. The objective lens drive device according to claim 4, wherein the tilt drive magnet is comprised of one piece of magnet which is disposed at a position opposed to the tilt drive coil.

9. The objective lens drive device according to claim 4, wherein the tilt drive magnet is constructed such that a plurality of magnets each of which is magnetized with single pole are integrated with each other, or such that the plurality of magnets are disposed in a close proximity, and the tilt drive magnet is disposed at a position opposing to the tilt drive coil.

10. The objective lens drive device according to claim 1, wherein the tilt drive mechanism is disposed on the other side end part side which is an opposite side to the lens holding part of the lens holder.

11. The objective lens drive device according to claim 10, wherein either a tilt drive coil or a tilt drive magnet of the tilt drive mechanism which is mounted on the lens holder is used as a counterweight for the lens holder which holds the objective lens.

12. An optical head device comprising an objective lens drive device as recited in claim 1.

13. In an optical head device, an objective drive device as recited in claim 1.
